(19) United States
(12) Patent Application Publication
(10) Pub. No.: US 2014/0315489 A1
(43) Pub. Date: Oct. 23, 2014

(54) METHOD FOR PERFORMING WIRELESS DISPLAY SHARING, AND ASSOCIATED APPARATUS AND ASSOCIATED COMPUTER PROGRAM PRODUCT

(71) Applicant: HTC CORPORATION, Taoyuan County (TW)

(72) Inventor: Li-Chung Lee, Taoyuan County (TW)

(73) Assignee: HTC Corporation, Taoyuan County (TW)

(21) Appl. No.: 13/868,053

(22) Filed: Apr. 22, 2013

(51) Int. Cl. G06F 3/14; H04M 1/725; H04W 4/00

(52) U.S. Cl. CPC G06F 3/1454; H04W 4/008; H04M 1/725
USPC 455/41.2

(57) ABSTRACT

A method and apparatus for performing wireless display sharing and an associated computer program product are provided, where the method is applied to an electronic device. The method includes the steps of: performing device detection by using a proximity sensing module of the electronic device to associate the electronic device with another electronic device to form a group, wherein the group may include a plurality of electronic devices such as the electronic device and the other electronic device; providing a user of the electronic device with a user interface to allow the user to select a specific digital data display arrangement type of a plurality of digital data display arrangement types for the electronic device; and obtaining data corresponding to the specific digital data display arrangement type and utilizing a display module of the electronic device to display the data.

### BACKGROUND OF THE INVENTION

1. Field of the Invention

The present invention relates to display control over a plurality of electronic devices that have their own display modules, respectively, and more particularly, to a method for performing wireless display sharing, and to an associated apparatus and an associated computer program product.

2. Description of the Prior Art

A conventional portable electronic device implemented according to the related art, such as a multifunctional mobile phone equipped with personal digital assistant (PDA) functionalities or a PDA equipped with mobile phone functionalities, may have become an important part of everyday life since it is very helpful. In a situation where the conventional portable electronic device is utilized for showing something to those around the user, some problems may occur. For example, the size of a liquid crystal display (LCD) module within the conventional portable electronic device may be too small if the viewers are many. In another example, the viewing experience may be degraded due to the small size of the LCD module within the conventional portable electronic device. Thus, a novel method is required for providing display control over a plurality of electronic devices comprising their own display modules, respectively.

### SUMMARY OF THE INVENTION

It is therefore an objective of the claimed invention to provide a method for performing wireless display sharing, and to provide an associated apparatus and an associated computer program product, in order to solve the above-mentioned problems.

According to at least one preferred embodiment, a method for performing wireless display sharing is provided, where the method is applied to an electronic device. The method comprises the steps of: performing device detection by using a proximity sensing module of the electronic device to associate the electronic device with another electronic device, in order to form a group, wherein the group comprises the electronic device and the other electronic device; providing a user of the electronic device with a user interface to allow the user to select a specific digital data display arrangement type of a plurality of digital data display arrangement types for the electronic device; and obtaining data corresponding to the specific digital data display arrangement type and utilizing a display module of the electronic device to display the data.

According to at least one preferred embodiment, an apparatus for performing wireless display sharing is also provided, where the apparatus comprises at least one portion of an electronic device. The apparatus comprises a display module, a proximity sensing module, and a processing circuit coupled to the display module and the proximity sensing module. The display module is arranged to display information, and the proximity sensing module is arranged to perform proximity sensing operations. In addition, the processing circuit is arranged to perform device detection by using the proximity sensing module to associate the electronic device with another electronic device, in order to form a group, wherein the group comprises the electronic device and the other electronic device. Additionally, the processing circuit provides a user of the electronic device with a user interface to allow the user to select a specific digital data display arrangement type of a plurality of digital data display arrangement types for the electronic device, and obtains data corresponding to the specific digital data display arrangement type and utilizes the display module to display the data.

According to at least one preferred embodiment, a computer program product is also provided, where the computer program product has program instructions for instructing a processor of an electronic device to perform a method comprising the steps of: performing device detection by using a proximity sensing module of the electronic device to associate the electronic device with another electronic device, in order to form a group, wherein the group comprises the electronic device and the other electronic device; providing a user of the electronic device with a user interface to allow the user to select a specific digital data display arrangement type of a plurality of digital data display arrangement types for the electronic device; and obtaining data corresponding to the specific digital data display arrangement type and utilizing a display module of the electronic device to display the data.

It is an advantage of the present invention that the aforementioned method, the aforementioned apparatus, and the aforementioned computer program product allow the user of the electronic device to utilize the display modules of a plurality of electronic devices in the group mentioned above (e.g. the electronic device and the other electronic device) as an enlarged and extended screen for the electronic device. In addition, the aforementioned method, the aforementioned apparatus, and the aforementioned computer program product allow the user of the electronic device to control the display arrangement of the plurality of electronic devices with ease. Additionally, the related art problems (e.g. the problem of the small size of the liquid crystal display (LCD) module within the conventional portable electronic device, and the problem of the degraded viewing experience) can be prevented.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for performing wireless display sharing according to an example.

FIG. 2 illustrates a wireless display sharing scheme involved with the apparatus shown in FIG. 1 according to an example, where the apparatus of this example can be a mobile device.

FIG. 3 illustrates a flowchart of a method for performing wireless display sharing according to an example.

FIG. 4 illustrates a wireless display sharing scheme involved with the method shown in FIG. 3 according to an example, where a master device and a slave device are utilized for displaying an enlarged version of the whole digital content.

FIG. 5 illustrates a wireless display sharing scheme involved with the method shown in FIG. 3 according to another example, where a master device and three slave devices are utilized for displaying an enlarged version of the whole digital content.

FIG. 6 illustrates a wireless display sharing scheme involved with the method shown in FIG. 3 according to another example, where a master device and three slave devices are utilized for displaying an enlarged version of the whole digital content.

FIG. 7 illustrates a set of digital data display arrangement types involved with the method shown in FIG. 3 according to an example.

FIG. 8 illustrates a set of digital data display arrangement types involved with the method shown in FIG. 3 according to another example.

FIG. 9 illustrates one of a set of digital data display arrangement types involved with the method shown in FIG. 3 according to another example.

FIG. 10 illustrates a working flow involved with the method shown in FIG. 3 according to an example.

FIG. 11 illustrates a wireless display sharing scheme involved with the method shown in FIG. 3 according to another example, where a master device and three slave devices are utilized for displaying an enlarged version of the whole digital content.

### DETAILED DESCRIPTION

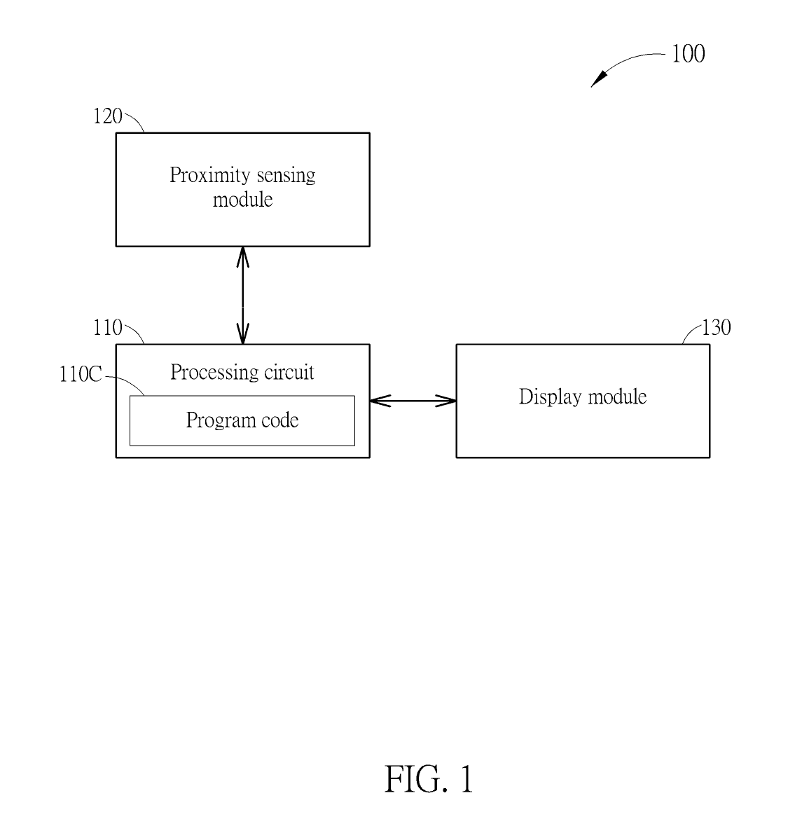

FIG. 1 is a diagram of an apparatus 100 for performing wireless display sharing, where the apparatus 100 may comprise at least one portion (e.g. a portion or all) of an electronic device. For example, the apparatus 100 may comprise a portion of the electronic device mentioned above, and more particularly, can be a control circuit such as an integrated circuit (IC) within the electronic device. In another example, the apparatus 100 can be the whole of the electronic device mentioned above. Examples of the electronic device may include, but not limited to, a mobile phone (e.g. a multifunctional mobile phone), a mobile computer (e.g. tablet computer), a personal digital assistant (PDA), and a personal computer such as a laptop computer.

As shown in FIG. 1, the apparatus 100 comprises a processing circuit 110, a proximity sensing module 120, and a display module 130, where the processing circuit 110 is arranged to control operations of the electronic device, the proximity sensing module 120 is arranged to perform proximity sensing operations, and the display module 130 is arranged to display information. For example, the proximity sensing module 120 can be a near field communication (NFC) module that is capable of performing NFC operations (e.g. operations of communication, tag identification, and data transmission), or can be a radio-frequency identification (RFID), Bluetooth (BT), Bluetooth low energy (BLE) or infrared (IR) sensor, and the display module 130 can be a touch sensitive display panel or a touch screen. Please note that the processing circuit 110 can be selectively implemented with the mixed scheme utilizing software (or firmware) module running on hardware circuit(s), or implemented with the pure hardware scheme. For example, the processing circuit 110 may comprise a processor and associated hardware circuits implemented by using at least one printed circuit board (PCB) on which the processor can be installed, and the aforementioned associated hardware circuit may comprise at least one memory (not shown) such as at least one random access memory (RAM) and/or at least one non-volatile memory (e.g. an electrically erasable programmable read only memory (EEPROM) or a Flash memory), where at least one program code 110C (e.g. one or more sets of program codes) may be stored in the aforementioned storage unit in advance and retrieved by the processing circuit 110 (more particularly, the processor mentioned above), for running on the processing circuit 110 as illustrated in FIG. 1. This is for illustrative purposes only, and is not meant to be a limitation. In another example, the processing circuit 110 may be implemented as pure hardware circuit(s), where the aforementioned program code 110C is imbedded therein.

In addition, the processing circuit 110 is further arranged to perform device detection by using the proximity sensing module 120 to associate the electronic device with another electronic device, in order to form a group, where the group may comprise the electronic device and the other electronic device. Additionally, the processing circuit 110 provides a user of the electronic device with a user interface to allow the user to select a specific digital data display arrangement type of a plurality of digital data display arrangement types for the electronic device, and obtains data corresponding to the specific digital data display arrangement type and utilizes the display module 130 to display the data.

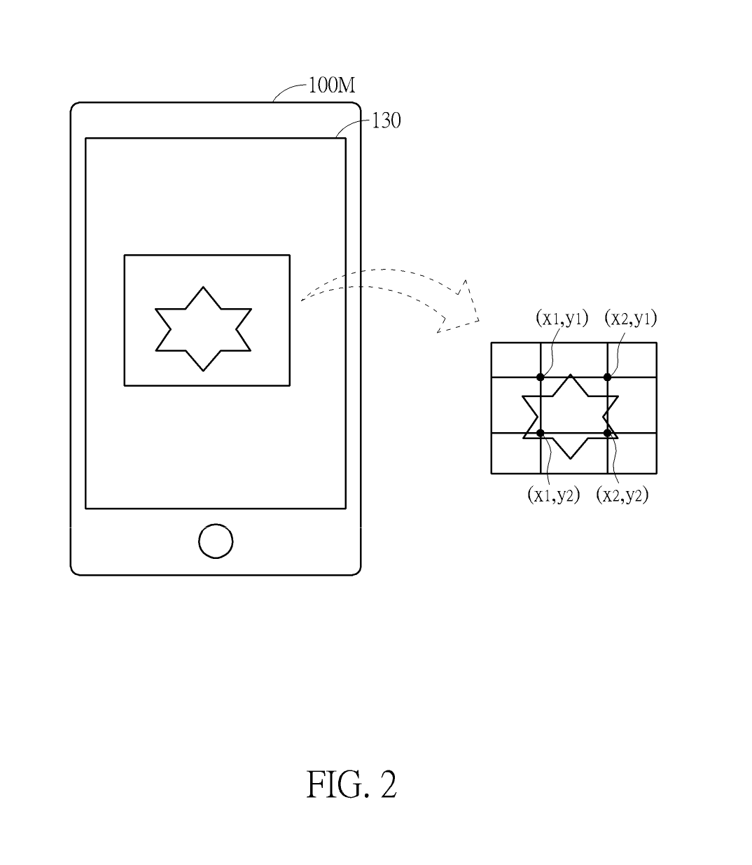

FIG. 2 illustrates a wireless display sharing scheme involved with the apparatus 100 shown in FIG. 1 according to an example, where the apparatus of this example can be a mobile device 100M (e.g. a mobile phone, a tablet, etc.). For example, the mobile device 100M is capable of utilizing the display module 130 to display a picture of a star as illustrated in FIG. 2, and is also capable of performing wireless display sharing to utilize the display module 130 and at least one display module of at least one other electronic device (e.g. the same product as the mobile device 100M) to display different portions of the aforementioned picture of the star, respectively. As a result, in a situation where the mobile device 100M and the aforementioned at least one other electronic device such as one or more copies of the mobile device 100M are put together, they can cooperate to display an enlarged version of the whole digital content (e.g. an enlarged version of the picture of the star) by using their display modules, respectively.

In practice, the processing circuit 110 may calculate different sets of coordinate values of different partial digital contents of the whole digital content, such as the sets of coordinate values (x₁, y₁), (x₂, y₁), (x₁, y₂), and (x₂, y₂) shown in FIG. 2, and convert the aforementioned different sets of coordinate values into those of the corresponding portions of the enlarged version of the whole digital content according to the plurality of digital data display arrangement types, for displaying the enlarged version of the whole digital content (e.g. the enlarged version of the picture of the star) by using the display modules of the mobile device 100M and the aforementioned at least one other electronic device (e.g. one or more copies of the mobile device 100M), respectively.

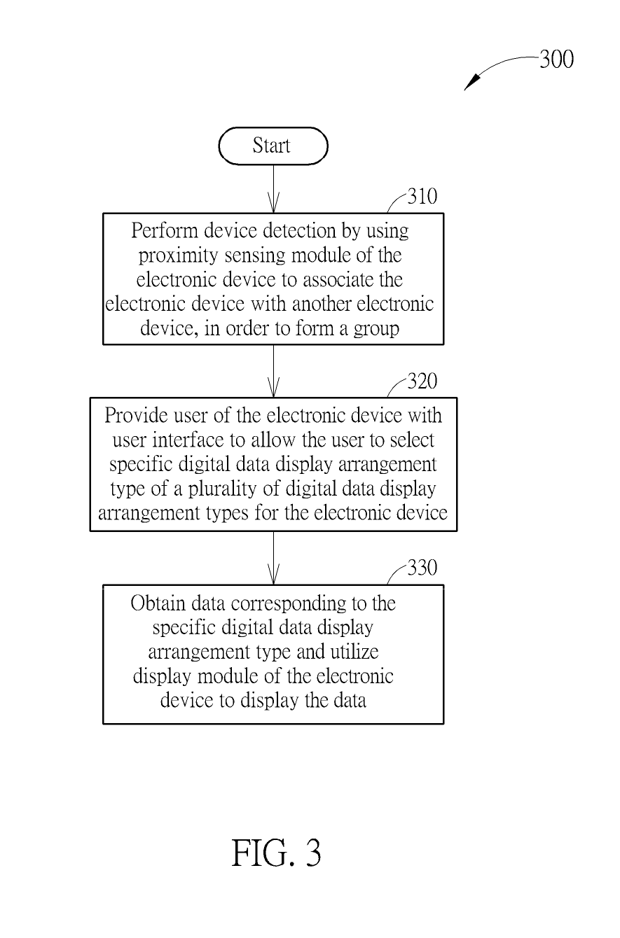

FIG. 3 illustrates a flowchart of a method 300 for performing wireless display sharing according to an example. The method shown in FIG. 3 can be applied to the apparatus 100 shown in FIG. 1 (more particularly, the mobile device 100M of the example shown in FIG. 2), and can be applied to the processing circuit 110 thereof (more particularly, the processing circuit 110 executing the program code 110C mentioned above). For example, the program code 110C may be provided through a computer program product having program instructions for instructing a processor such as that mentioned above to perform the method 300 shown in FIG. 3, where the computer program product may be implemented as a non-transitory computer-readable medium (e.g. a floppy disk or a compact disc-read only memory (CD-ROM)) storing the program instructions or an equivalent version thereof, such as a software package for being installed. The method is described as follows.

In Step 310, the processing circuit 110 performs device detection by using the proximity sensing module 120 to associate the electronic device with another electronic device to form a group. For example, the group is formed with a plurality of electronic devices comprising the electronic device and the other electronic device, and the plurality of electronic devices comprises their own display modules, respectively. More particularly, the group may represent the plurality of electronic devices put together with their display modules being arranged to be a display module array, such as a one-dimensional display module array or a two-dimensional display module array.

In Step 320, the processing circuit 110 provides the user of the electronic device with the user interface to allow the user to select a specific digital data display arrangement type of a plurality of digital data display arrangement types, such as the aforementioned specific digital data display arrangement type of the plurality of digital data display arrangement types, for the electronic device, where the digital data display arrangement types are a plurality of types of digital data display arrangement, respectively. Thus, the specific digital data display arrangement type can be regarded as a specific type of digital data display arrangement selected from the plurality of types of digital data display arrangement.

In Step 330, the processing circuit 110 obtains the data corresponding to the specific digital data display arrangement type and utilizes the display module 130 to display the data. For example, in a situation where the group is formed with the plurality of electronic devices mentioned above, under control of at least one of the electronic device and the other electronic device, different partial digital contents of the whole digital content (e.g. different partial digital contents of the aforementioned enlarged version of the picture of the star) are displayed on the display modules of the electronic devices at the same time, respectively.

More particularly, one of the electronic device and the other electronic device mentioned in Step 310 can be a master device that controls the other(s) of the plurality of electronic devices to act as at least one extended screen of the master device, and the aforementioned other(s) of the plurality of electronic devices can be slave device(s) that display partial digital contents of the whole digital content for the master device.

For example, in a situation where the electronic device mentioned in Step 310 is the master device and the aforementioned other(s) of the plurality of electronic devices are slave device(s), the processing circuit 110 utilizes the display module 130 of the electronic device to display a partial digital content of the whole digital content according to the data corresponding to the specific digital data display arrangement type, where the relative location of the partial digital content with respect to the whole digital content corresponds to the specific digital data display arrangement type. More particularly, the processing circuit 110 can control the electronic device to transmit other data corresponding to another digital data display arrangement type of the plurality of digital data display arrangement types or a source location (e.g. for retrieving or downloading the other data) of the other data to the other electronic device, for displaying the other data on the display module of the other electronic device. As a result, another partial digital content of the whole digital content is displayed on the display module of the other electronic device according to the other data corresponding to the other digital data display arrangement type, where the relative location of the other partial digital content with respect to the whole digital content corresponds to the other digital data display arrangement type. In practice, the processing circuit 110 may control the electronic device to transmit a set of coordinate values that indicates the relative location of the other partial digital content with respect to the whole digital content to the other electronic device, so that the other electronic device knows which part of the whole digital content to show on display.

In another example, in a situation where the other electronic device mentioned in Step 310 is the master device and the aforementioned other(s) of the plurality of electronic devices are slave device(s), the processing circuit 110 controls the electronic device to receive the data corresponding to the specific digital data display arrangement type or a source location of the data from the other electronic device. In addition, the processing circuit 110 utilizes the display module 130 of the electronic device to display a partial digital content of the whole digital content according to the data corresponding to the specific digital data display arrangement type, where the relative location of the partial digital content with respect to the whole digital content corresponds to the specific digital data display arrangement type. More particularly, another partial digital content of the whole digital content is displayed on the display module of the other electronic device according to other data corresponding to another digital data display arrangement type of the plurality of digital data display arrangement types, where the relative location of the other partial digital content with respect to the whole digital content corresponds to the other digital data display arrangement type. In practice, the processing circuit 110 may control the electronic device to receive a set of coordinate values that indicates the relative location of the partial digital content with respect to the whole digital content from the other electronic device, so that the other electronic device knows which part of the whole digital content to show on display.

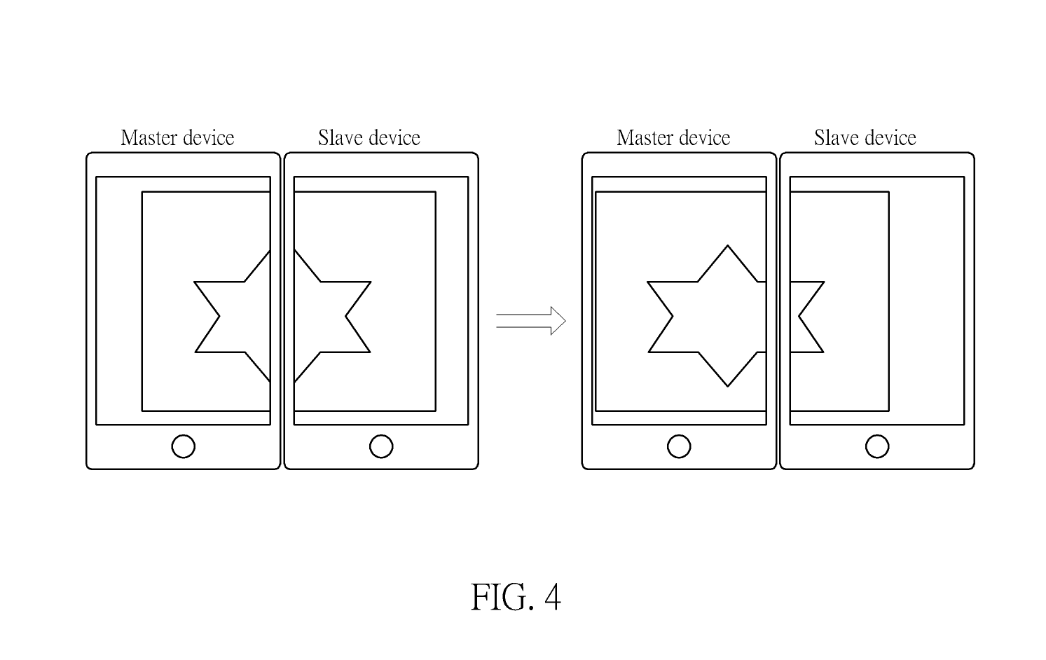

FIG. 4 illustrates a wireless display sharing scheme involved with the method 300 shown in FIG. 3 according to an example, where a master device and one slave device are utilized for displaying an enlarged version of the whole digital content.

For example, when two friends come together with their own mobile phones (e.g. the master device and the slave device shown in FIG. 4) in hands, they may put their mobile phones to display different portions of an image, such as the left half part and the right half part of the star, respectively, in order to have fun or to utilize the touch sensitive display panels of their mobile phones as an enlarged screen. More particularly, as shown in the left half side of FIG. 4, when the two mobile phones are close to each other, the one that is set to be the master device may perform a screen split operation and may distribute the display data of the right half of the star to the slave device for being displayed, where the master device may control the display contents of the touch sensitive display panel of the salve device. In addition, as shown in the right half side of FIG. 4, when the user touch the touch sensitive display panel of the master device to move the star leftward, the whole digital content is moved leftward correspondingly, so that the combination of the touch sensitive display panels of the two mobile phones seems to be the enlarged screen of the master device.

Regarding the device detection mentioned in Step 310, for example, the proximity sensing module 120 can be, but not limited to, an NFC module such as that mentioned above, and can be utilized for performing NFC detection. In practice, the NFC module of the slave device can be regarded as an NFC tag, and the NFC module of the master device may detect that the two mobile phones (e.g. the master device and the slave device shown in FIG. 4) are close to each other and can be utilized for sending data (e.g. display data such as that mentioned above or the source location of the display data, or a set of coordinate values such as that mentioned above) from the master device to the salve device. More particularly, when it is detected that the user is triggering a movement of the whole digital content on the screen, the master device utilizes its NFC module to send the associated data (e.g. display data such as that mentioned above or the source location of the display data, or a set of coordinate values such as that mentioned above) to the salve device. For example, the picture of the star is originally displayed on the touch sensitive display panel of the master device, and under control of the processing circuit thereof (which can be taken as an example of the processing circuit 110 of the electronic device), the picture of the star is marked with multiple sets of coordinate values such as the sets of coordinate values (x₁, y₁), (x₂, y₁), (x₁, y₂), and (x₂, y₂) shown in FIG. 2. If the user pinches the picture to enlarge or to move this picture, the master device utilizes its NFC module to send the associated coordinate data such as the converted sets of coordinate values of the corresponding portions of the enlarged version of the whole digital content to the slave device. As a result, the picture displayed by the slave device can be moved accordingly, so that the combination of the touch sensitive display panels of the two mobile phones seems to be the enlarged screen of the master device. This is for illustrative purposes only, and is not meant to be a limitation. In some other examples, the number of slave device can be more than one. In addition, the method 300 shown in FIG. 3 can be utilized for showing a video clip, a movie clip, photos, maps, or any kinds of digital contents. In these examples, the master device may have options to pair itself up with each of a number of slave devices and to choose different types of display arrangement of their display modules (e.g. touch sensitive display panels), where the master device sends data to the slave devices to notify them of the position and the movement of the partial digital contents to be displayed, respectively. Noticeably, the data sent between devices could be through other wireless connections such as Bluetooth or Wi-Fi connection instead of the proximity sensor such as NFC, however the wireless connection is not limited here.

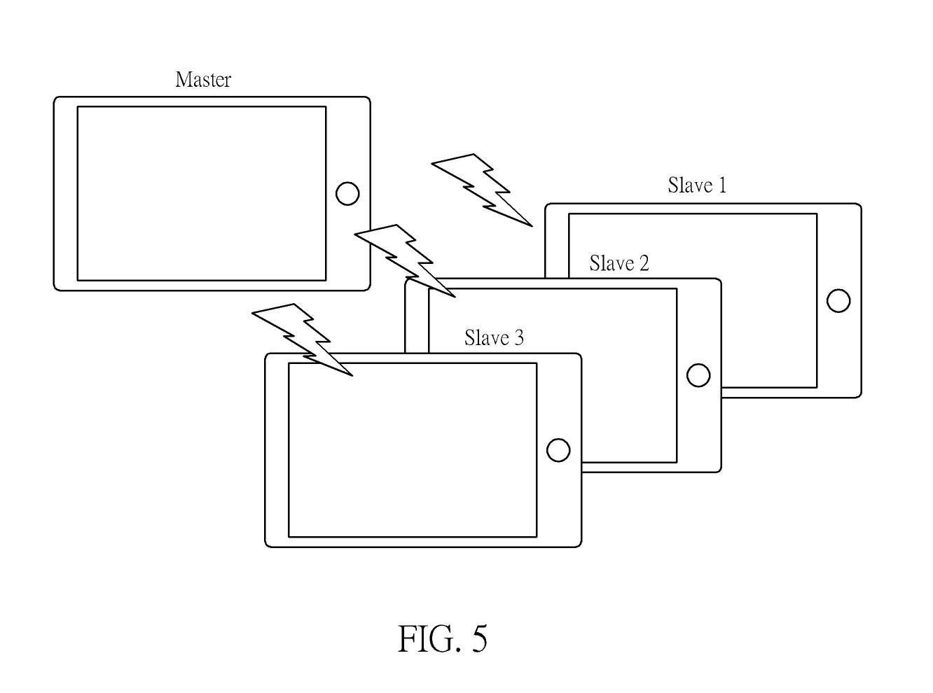

FIG. 5 illustrates a wireless display sharing scheme involved with the method 300 shown in FIG. 3 according to another example, where a master device such as that mentioned above and three slave devices such as that mentioned above are utilized for displaying an enlarged version of the whole digital content. For example, the proximity sensing module 120 can be an NFC module, and can be utilized for performing NFC detection. Similar descriptions are not repeated in detail here.

In another example, as long as the implementation of screen sharing via the master device and one or more slave devices is not hindered, the aforementioned NFC detection can be replaced by Bluetooth (BT) detection. More particularly, the proximity sensing module 120 can be a BT module for performing BT communication (e.g. operations of BT pairing up and BT connection) to achieve the same goal of screen sharing as that of the above examples. Similar descriptions are not repeated in detail here.

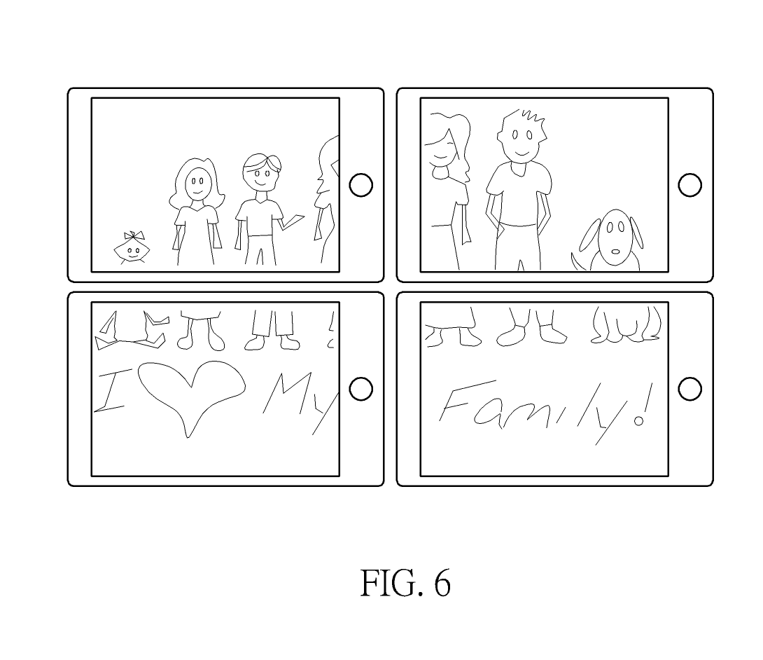

FIG. 6 illustrates a wireless display sharing scheme involved with the method 300 shown in FIG. 3 according to another example, where a master device such as that mentioned above and three slave devices such as that mentioned above are utilized for displaying an enlarged version of the whole digital content (e.g. the enlarged version of the picture of the user's family). Similar descriptions are not repeated in detail here.

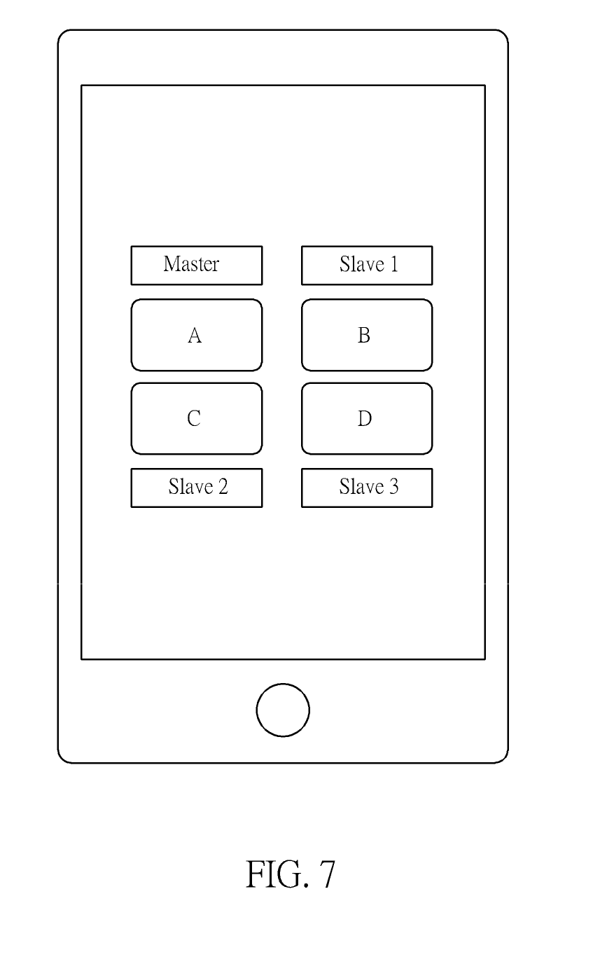

FIG. 7 illustrates a set of digital data display arrangement types involved with the method 300 shown in FIG. 3 according to an example. Here, the notations “A”, “B”, “C”, and “D” can be utilized for representing different digital data display arrangement types within the plurality of digital data display arrangement types mentioned in Step 320, respectively, and more particularly, for representing different positions of the electronic devices that form the group mentioned in Step 310, respectively, where the position of a specific electronic device of these electronic devices with respect to that of the whole of the group typically corresponds to the relative location of the partial digital content with respect to the whole digital content, and also defines the partial digital content to be displayed by the specific electronic device. In this example, the type A means the upper left position in the group, the type B means the upper right position in the group, the type C means the lower left position in the group, and the type D means the lower right position in the group.

As shown in FIG. 7, the user interface mentioned in Step 320 may comprise multiple UI objects (i.e. user interface objects) such as four mobile phone icons representing the electronic devices that form the group mentioned in Step 310, respectively, and may further comprise some hint messages such as the banners of “Master”, “Slave 1”, “Slave 2”, and “Slave 3”, which stand for the master device, the slave device No. 1, the slave device No. 2, and the slave device No. 3, respectively. For better comprehension, the UI objects of this example are labeled with the aforementioned notations {A, B, C, D} representing the aforementioned different digital data display arrangement types, respectively. This is for illustrative purposes only, and is not meant to be a limitation. In another example, it is unnecessary to label the UI objects with the notations {A, B, C, D}, respectively. Please note that the whole digital content of the example shown in FIG. 7 is divided into quarters to be further combined by putting the master device, the slave device No. 1, the slave device No. 2, and the slave device No. 3 together as illustrated in the user interface shown in FIG. 7.

In a situation where the user touches one of the UI objects shown in FIG. 7, the processing circuit 110 detects that the user selects the specific digital data display arrangement type mentioned in Step 320, where the specific digital data display arrangement type corresponds to the UI object touched by the user. For example, for the master device in this example, the user may touch the UI object labeled “A” to set the electronic device mentioned in Step 310 as the upper left one of the group. As a result, the electronic device mentioned in Step 310 displays the upper left quarter of the whole digital content (e.g. the upper left quarter of the enlarged version of the picture of the user's family). In another example, for the slave device No. 1 in this example, the user may touch the UI object labeled “B” to set the electronic device mentioned in Step 310 as the upper right one of the group. As a result, the electronic device mentioned in Step 310 displays the upper right quarter of the whole digital content. In another example, for the slave device No. 2 in this example, the user may touch the UI object labeled “C” to set the electronic device mentioned in Step 310 as the lower left one of the group. As a result, the electronic device mentioned in Step 310 displays the lower left quarter of the whole digital content. In another example, for the slave device No. 3 in this example, the user may touch the UI object labeled “D” to set the electronic device mentioned in Step 310 as the lower right one of the group. As a result, the electronic device mentioned in Step 310 displays the lower right quarter of the whole digital content.

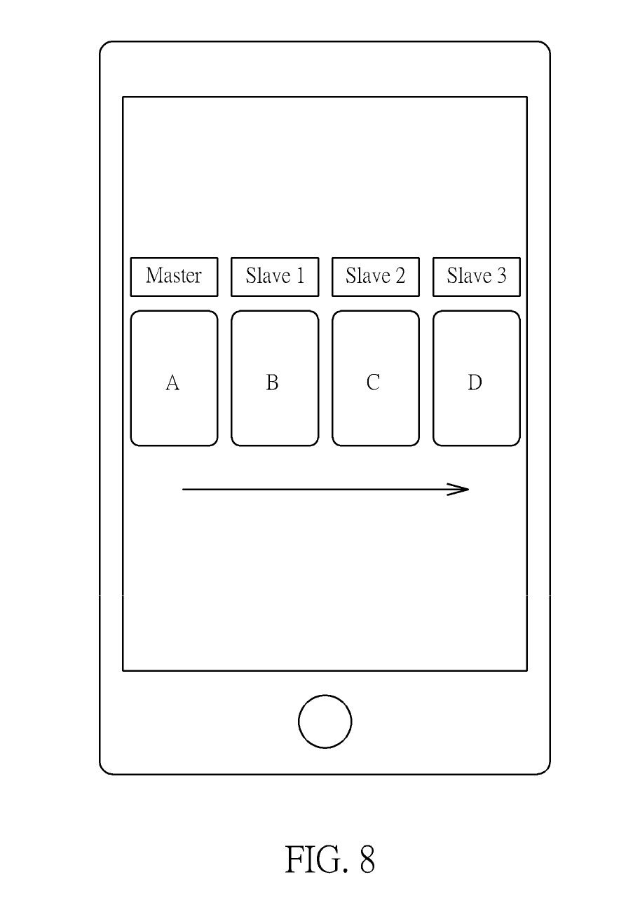

Similar to FIG. 7, FIG. 8 illustrates a set of digital data display arrangement types involved with the method 300 shown in FIG. 3 according to another example. Here, the notations “A”, “B”, “C”, and “D” can be utilized for representing different digital data display arrangement types within the plurality of digital data display arrangement types mentioned in Step 320, respectively. In this example, the type A means the leftmost position in the group, the type B means the position next to the leftmost position in the group, the type C means the position next to the rightmost position in the group, and the type D means the rightmost position in the group.

As shown in FIG. 8, the user interface mentioned in Step 320 may comprise multiple UI objects such as four mobile phone icons representing the electronic devices that form the group mentioned in Step 310, respectively, and may further comprise some hint messages such as the banners of “Master”, “Slave 1”, “Slave 2”, and “Slave 3”, which stand for the master device, the slave device No. 1, the slave device No. 2, and the slave device No. 3, respectively. For better comprehension, the UI objects of this example are labeled with the notations {A, B, C, D} representing the aforementioned different digital data display arrangement types, respectively. This is for illustrative purposes only, and is not meant to be a limitation. Please note that the whole digital content of the example shown in FIG. 8 is divided into four vertical strips to be further combined by putting the master device, the slave device No. 1, the slave device No. 2, and the slave device No. 3 together as illustrated in the user interface shown in FIG. 8.

In a situation where the user touches one of the UI objects shown in FIG. 8, the processing circuit 110 detects that the user selects the specific digital data display arrangement type mentioned in Step 320. For example, for the master device in this example, the user may touch the UI object labeled “A” to set the electronic device mentioned in Step 310 as the leftmost one of the group. As a result, the electronic device mentioned in Step 310 displays the leftmost strip of the whole digital content. In another example, for the slave device No. 1 in this example, the user may touch the UI object labeled “B” to set the electronic device mentioned in Step 310 as the one next to the leftmost one of the group. As a result, the electronic device mentioned in Step 310 displays the next strip of the whole digital content. In another example, for the slave device No. 2 in this example, the user may touch the UI object labeled “C” to set the electronic device mentioned in Step 310 as the one next to the rightmost one of the group. As a result, the electronic device mentioned in Step 310 displays the third strip of the whole digital content. In another example, for the slave device No. 3 in this example, the user may touch the UI object labeled “D” to set the electronic device mentioned in Step 310 as the rightmost one of the group. As a result, the electronic device mentioned in Step 310 displays the last strip of the whole digital content.

In another example, the user interface shown in FIG. 8 can be utilized for setting the master device, the slave device No. 1, the slave device No. 2, and the slave device No. 3 in the group to display the same image, rather than different partial digital contents of the whole digital content mentioned above.

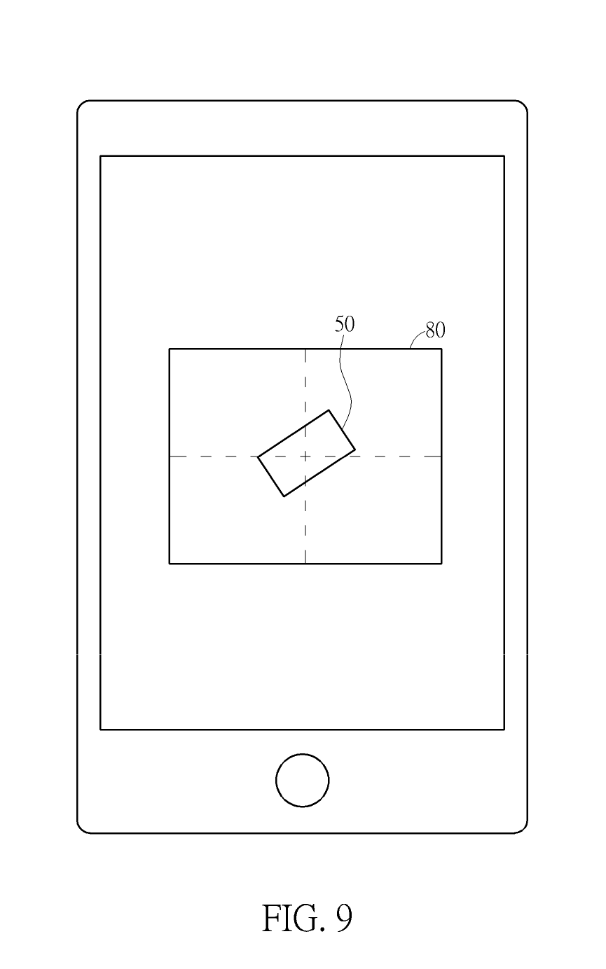

FIG. 9 illustrates one of a set of digital data display arrangement types involved with the method 300 shown in FIG. 3 according to another example. The user interface shown in FIG. 9 allows the user to arbitrarily select a portion of the whole digital content, such as the portion defined by a mark 50 (e.g. a rectangle in this example) that can be moved or rotated in response to the user's gesture performed on the touch sensitive display panel. For example, the user moves the mark 50 to be aligned to the center of the whole image 80 and rotates the mark 50 to be inclined, forming an angle (e.g. an angle that is not equal to ninety degree in this example) with the vertical or the horizontal dashed lines indicating the center. As a result, the processing circuit 110 detects that the user selects the specific digital data display arrangement type mentioned in Step 320, where the specific digital data display arrangement type corresponds to the mark 50 whose relative location and angle are defined by the user.

In this example, the number of digital data display arrangement types in the plurality of digital data display arrangement types is much greater than that of any of the examples shown in FIGS. 7-8 especially the relative location and the angle of the mark 50 can be arbitrarily defined by the user. In addition, the mark 50 shown in FIG. 9 is illustrated within the boundaries of the whole image 80 shown in FIG. 9. This is for illustrative purposes only, and is not meant to be a limitation. In some other examples, the user interface mentioned in Step 320 allows the user to move the mark 50 across the boundaries of the whole image 80 shown in FIG. 9.

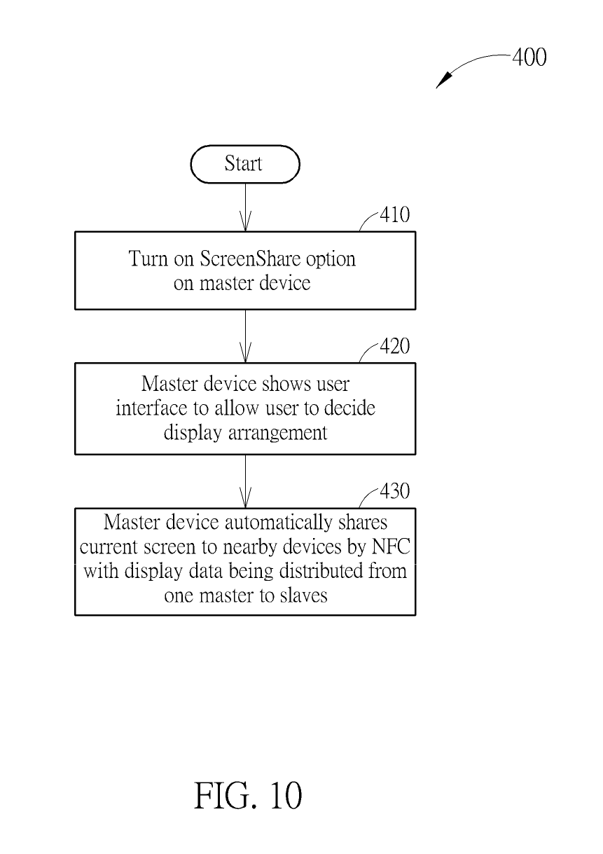

FIG. 10 illustrates a working flow 400 involved with the method 300 shown in FIG. 3 according to an example. Here, an application (APP) named “ScreenShare” (which stands for screen sharing) can be taken as an example of the program code 110C shown in FIG. 1.

In Step 410, the processing circuit 110 running the APP, “ScreenShare”, turns on the ScreenShare option on the master device.

In Step 420, under control of the processing circuit 110 running the APP, “ScreenShare”, the master device shows the user interface mentioned in Step 320 to allow the user to decide display arrangement, such as the display arrangement of the display modules within the display module array mentioned above.

In Step 430, under control of the processing circuit 110 running the APP, “ScreenShare”, the master device automatically shares the current screen to nearby devices by NFC with display data (or the source location of the display data) being distributed from one master to slaves. As a result, the partial digital contents of the whole digital content are displayed on the display modules of the master device and the slave devices, causing the display module array mentioned above to be an enlarged and extended screen for the master device.

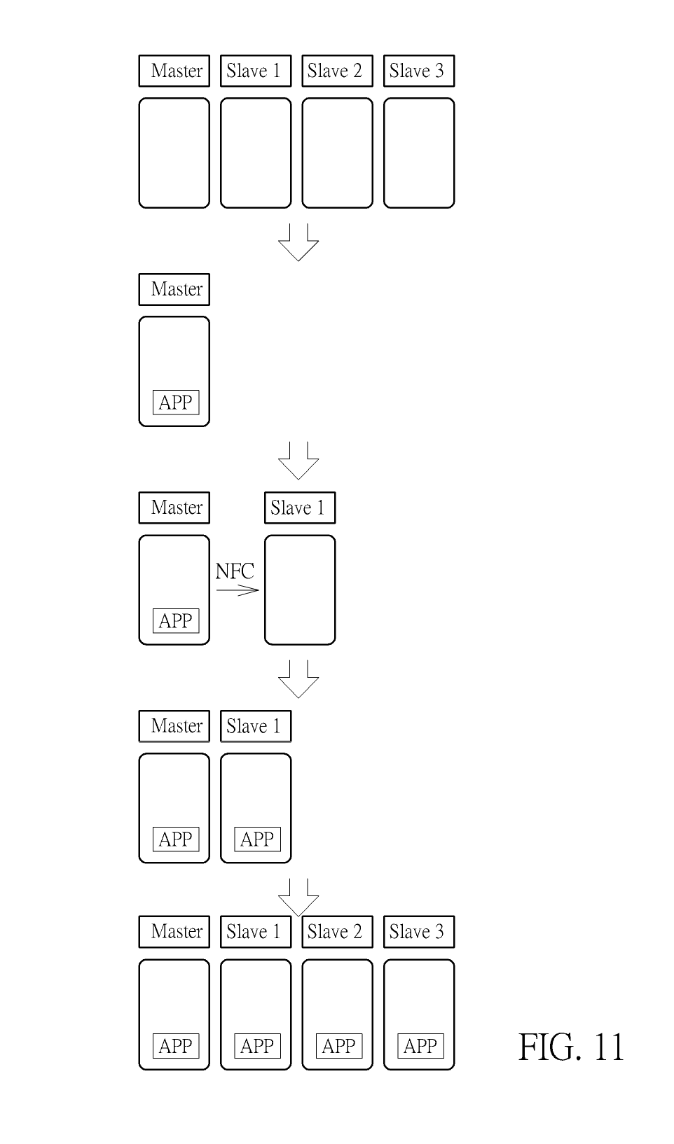

FIG. 11 illustrates a wireless display sharing scheme involved with the method 300 shown in FIG. 3 according to another example, where a master device such as that mentioned above and three slave devices such as that mentioned above are utilized for displaying an enlarged version of the whole digital content.

In the beginning, during the first stage shown in the uppermost of FIG. 11, the electronic devices that form the group mentioned in Step 310 are put together. More particularly, the electronic devices that form the group mentioned in Step 310 may comprise four electronic devices such as the master device, the slave device No. 1, the slave device No. 2, and the slave device No. 3 mentioned in any of the examples shown in FIGS. 7-8. In this example, the aforementioned APP, “ScreenShare”, has been installed in each of the master device, the slave device No. 1, the slave device No. 2, and the slave device No. 3, and the NFC function of each of the master device, the slave device No. 1, the slave device No. 2, and the slave device No. 3 has been turned on. Please note that, although each of the electronic devices that form the group mentioned in Step 310 can be the same as the mobile device 100M of the example shown in FIG. 2, different portions of the program instructions in the aforementioned APP, “ScreenShare”, may be activated to make the electronic devices that form the group mentioned in Step 310 play the roles of the master device, the slave device No. 1, the slave device No. 2, and the slave device No. 3, respectively.

In practice, the NFC can be regarded as a peer to peer technique, so the master device has to approach the slave device No. 1, the slave device No. 2, and the slave device No. 3, respectively, one at a time. For example, the master device may approach the slave device No. 1 first, and then approach the slave device No. 2, and then approach the slave device No. 3.

During the next stage shown in FIG. 11, the aforementioned APP, “ScreenShare”, is launched on the master device, where a block labeled “APP” is illustrated within the master device, for better comprehension. Then, the master device may approach one of the three salve devices, such as the slave device No. 1 in this example. When NFC detection is performed, the master device detects that the slave device No. 1 is put nearby. As shown in FIG. 11, notification information can further be passed from the master device to the slave device No. 1 through NFC communication (labeled “NFC” in FIG. 11). As a result, upon the trigger of the master device, the slave device No. 1 launches the APP, “ScreenShare”, automatically and receives the notification from the master device, such as the notification indicating that the master device is going to start operations of screen sharing, where a block labeled “APP” is illustrated within the slave device No. 1, for better comprehension. In addition, the slave device No. 1 can automatically accept the request from the master device and perform screen sharing by using the aforementioned APP, “ScreenShare”, that is launched on the slave device No. 1. This is for illustrative purposes only, and is not meant to be a limitation. In another example, the slave device No. 1 can either reject or accept the request from the master device, rather then automatically accepting the request from the master device.

Similarly, the master device continues to pair itself up with each of the rest of the three slave devices, such as the slave device No. 2 and the slave device No. 3, one by one until each of the slave devices launches the aforementioned APP, “ScreenShare”, and is paired up with the master device. As shown in the bottommost of FIG. 11, under control of the master device, the aforementioned APP, “ScreenShare”, is eventually launched in each of the slave device No. 1, the slave device No. 2, and the slave device No. 3, where each of the slave device No. 1, the slave device No. 2, and the slave device No. 3 is capable of receiving the display data (or the source location of the display data) and the display arrangement information (e.g. the aforementioned different sets of coordinate values of different partial digital contents of the whole digital content, such as the sets of coordinate values (x₁, y₁), (x₂, y₁), (x₁, y₂), and (x₂, y₂) shown in FIG. 2) from the master device. Therefore, the operations of screen sharing can be performed across multiple electronic devices, such as the electronic devices that form the group mentioned in Step 310.

In a situation where the whole digital content mentioned above is a photo such as that mentioned above, the master device can transmit the associated information of the operations of screen sharing to the slave devices, respectively, such as the location information, the rotation information, and/or the movement information of the partial digital contents to be displayed by the slave devices, respectively. As a result, the user may utilize the master device, the slave device No. 1, the slave device No. 2, and the slave device No. 3 to display the enlarged version of the whole digital content, and control through the master device. For example, by using some gestures input through the touch sensitive display panel of the master device, the user may apply various kinds of operations (e.g. the operations of zoom in, zoom out, rotation, and move, etc.) on the enlarged version of the whole digital content.

In a situation where the whole digital content mentioned above is an image corresponding to a specific time stamp in a video clip and assuming that the video clip source file or the streaming URL had been obtained by all slave devices in group from the mater device, the master device can transmit the associated information of the operations of screen sharing to the slave devices, respectively, such as the time stamp information, in order to synchronize the playback of the video clip on each of the electronic devices that form the group mentioned in Step 310. As a result, the user may utilize the master device, the slave device No. 1, the slave device No. 2, and the slave device No. 3 to display the enlarged version of the whole digital content (e.g. the enlarged version of the image corresponding to the specific time stamp in the video clip), and control through the master device. For example, by using some gestures input through the touch sensitive display panel of the master device, the user may apply various kinds of operations (e.g. the operations of play, stop, jump, fast forward, fast backward, etc.) on the enlarged version of the video clip.

According to an aspect, the aforementioned computer program product can be composed of several code segments. In addition, after these code segments are loaded into the apparatus 100 (more particularly, the processing circuit 110) and are executed, the steps and features of the method shown in FIG. 3 can be implemented.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing wireless display sharing, the method being applied to an electronic device, the method comprising the steps of:
performing device detection by using a proximity sensing module of the electronic device to associate the electronic device with another electronic device, in order to form a group, wherein the group comprises the electronic device and the other electronic device;
providing a user of the electronic device with a user interface to allow the user to select a specific digital data display arrangement type of a plurality of digital data display arrangement types for the electronic device; and
obtaining data corresponding to the specific digital data display arrangement type and utilizing a display module of the electronic device to display the data.

2. The method of claim 1, further comprising:
utilizing the display module of the electronic device to display a partial digital content of a whole digital content according to the data corresponding to the specific digital data display arrangement type, wherein a relative location of the partial digital content with respect to the whole digital content corresponds to the specific digital data display arrangement type.

3. The method of claim 2, further comprising:
transmitting other data corresponding to another digital data display arrangement type of the plurality of digital data display arrangement types or a source location of the other data to the other electronic device, for displaying the other data on a display module of the other electronic device.

4. The method of claim 3, wherein another partial digital content of the whole digital content is displayed on the display module of the other electronic device according to the other data corresponding to the other digital data display arrangement type; and a relative location of the other partial digital content with respect to the whole digital content corresponds to the other digital data display arrangement type.

5. The method of claim 4, further comprising:
transmitting a set of coordinate values that indicates the relative location of the other partial digital content with respect to the whole digital content to the other electronic device.

6. The method of claim 1, further comprising:
receiving the data corresponding to the specific digital data display arrangement type or a source location of the data from the other electronic device.

7. The method of claim 6, further comprising:
utilizing the display module of the electronic device to display a partial digital content of a whole digital content according to the data corresponding to the specific digital data display arrangement type, wherein a relative location of the partial digital content with respect to the whole digital content corresponds to the specific digital data display arrangement type.

8. The method of claim 7, further comprising:
receiving a set of coordinate values that indicates the relative location of the partial digital content with respect to the whole digital content from the other electronic device.

9. The method of claim 7, wherein another partial digital content of the whole digital content is displayed on a display module of the other electronic device according to other data corresponding to another digital data display arrangement type of the plurality of digital data display arrangement types; and a relative location of the other partial digital content with respect to the whole digital content corresponds to the other digital data display arrangement type.

10. The method of claim 1, wherein the group is formed with a plurality of electronic devices comprising the electronic device and the other electronic device, and the plurality of electronic devices comprises their own display modules, respectively; and under control of at least one of the electronic device and the other electronic device, different partial digital contents of a whole digital content are displayed on the display modules of the electronic devices at a same time, respectively.

11. An apparatus for performing wireless display sharing, the apparatus comprising at least one portion of an electronic device, the apparatus comprising:
a display module arranged to display information;
a proximity sensing module arranged to perform proximity sensing operations; and
a processing circuit, coupled to the display module and the proximity sensing module, arranged to perform device detection by using the proximity sensing module to associate the electronic device with another electronic device, in order to form a group, wherein the group comprises the electronic device and the other electronic device, and the processing circuit provides a user of the electronic device with a user interface to allow the user to select a specific digital data display arrangement type of a plurality of digital data display arrangement types for the electronic device, and obtains data corresponding to the specific digital data display arrangement type and utilizes the display module to display the data.

12. The apparatus of claim 11, wherein the processing circuit utilizes the display module of the electronic device to display a partial digital content of a whole digital content according to the data corresponding to the specific digital data display arrangement type; and a relative location of the partial digital content with respect to the whole digital content corresponds to the specific digital data display arrangement type.

13. The apparatus of claim 12, wherein the processing circuit controls the electronic device to transmit other data corresponding to another digital data display arrangement type of the plurality of digital data display arrangement types or a source location of the other data to the other electronic device, for displaying the other data on a display module of the other electronic device.

14. The apparatus of claim 13, wherein another partial digital content of the whole digital content is displayed on the display module of the other electronic device according to the other data corresponding to the other digital data display arrangement type; and a relative location of the other partial digital content with respect to the whole digital content corresponds to the other digital data display arrangement type.

15. The apparatus of claim 14, wherein the processing circuit controls the electronic device to transmit a set of coordinate values that indicates the relative location of the other partial digital content with respect to the whole digital content to the other electronic device.

16. The apparatus of claim 11, wherein the processing circuit controls the electronic device to receive the data corresponding to the specific digital data display arrangement type or a source location of the data from the other electronic device.

17. The apparatus of claim 16, wherein the processing circuit utilizes the display module of the electronic device to display a partial digital content of a whole digital content according to the data corresponding to the specific digital data display arrangement type; and a relative location of the partial digital content with respect to the whole digital content corresponds to the specific digital data display arrangement type.

18. The apparatus of claim 17, wherein the processing circuit controls the electronic device to receive a set of coordinate values that indicates the relative location of the partial digital content with respect to the whole digital content from the other electronic device.

19. The apparatus of claim 17, wherein another partial digital content of the whole digital content is displayed on a display module of the other electronic device according to other data corresponding to another digital data display arrangement type of the plurality of digital data display arrangement types; and a relative location of the other partial digital content with respect to the whole digital content corresponds to the other digital data display arrangement type.

20. A computer program product, having program instructions for instructing a processor of an electronic device to perform a method comprising the steps of:
performing device detection by using a proximity sensing module of the electronic device to associate the electronic device with another electronic device, in order to form a group, wherein the group comprises the electronic device and the other electronic device;
providing a user of the electronic device with a user interface to allow the user to select a specific digital data display arrangement type of a plurality of digital data display arrangement types for the electronic device; and
obtaining data corresponding to the specific digital data display arrangement type and utilizing a display module of the electronic device to display the data.
